(19) United States
(12) Patent Application Publication
(10) Pub. No.: US 2013/0306354 A1
(43) Pub. Date: Nov. 21, 2013

(54) SIGNAL WIRE PROTECTION DEVICE

(71) Applicant: WISTRON CORPORATION, New Taipei City (TW)

(72) Inventor: Hong-Wei LEE, New Taipei City (TW)

(73) Assignee: WISTRON CORPORATION, New Taipei City (TW)

(21) Appl. No.: 13/672,407

(22) Filed: Nov. 8, 2012

(30) Foreign Application Priority Data
May 21, 2012 (CN) 201210159609.4

(51) Int. Cl. H01B 7/17

(52) U.S. Cl. CPC H01B 7/17
USPC 174/135

(57) ABSTRACT

A signal wire protection device is disclosed. The signal wire protection device is installed on a signal wire having an adapter for protecting the signal wire. The signal wire protection device includes a main body bent to form a tubular structure such that the inner space of the main body forms a containing space for containing the signal wire. A side of the main body is disposed with an opening connected to the containing space; the main body is made of an elastic material so that the signal wire can pass through the opening and enter the containing space via elastic deformation of the main body.

### BACKGROUND OF THE INVENTION

1. Field of the Invention

The present invention relates to a signal wire protection device, and more particularly, to a signal wire protection device made of an elastic material.

2. Description of the Related Art

Since the signal wire used for the automatic pull plug force test is required to conform to strict standards for resistance and other parameters, the signal wire is usually made of a special wire material different from general wire materials used for other tests. However, the signal wire made of a special wire material tends to be soft, so an adapter of the signal wire can easily be damaged. Once the port is damaged, the signal wire cannot perform the test correctly. Therefore, a signal wire protection device in the prior art was proposed to enhance the durability and to extend the life span of the signal wire.

Please refer to FIG. 1 for a view of a prior art signal wire protection device 1a. As shown in FIG. 1, the signal wire protection device 1a can be installed on a signal wire 90 to protect the signal wire 90. However, a main body 10a of the signal wire protection device 1a is made of wooden material, which is expensive in cost and is also heavy and difficult to install, making it inconvenient for workers to operate the prior art signal wire protection device.

Therefore, it is necessary to provide a new signal wire protection device to solve the problems encountered by the signal wire protection devices of the prior art.

### SUMMARY OF THE INVENTION

It is an object of the present invention to provide a signal wire protection device made of an elastic material.

In order to achieve the above object, the signal wire protection device of the present invention is installed on a signal wire having an adapter for protecting the signal wire.

The signal wire protection device comprises a main body bent to form a tubular structure, such that the inner space of the main body forms a containing space for containing the signal wire. A side of the main body is disposed with an opening connected to the containing space. The main body is made of an elastic material so that the signal wire can pass through the opening and enter the containing space via elastic deformation of the main body.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 illustrates a view of a prior art signal wire protection device.

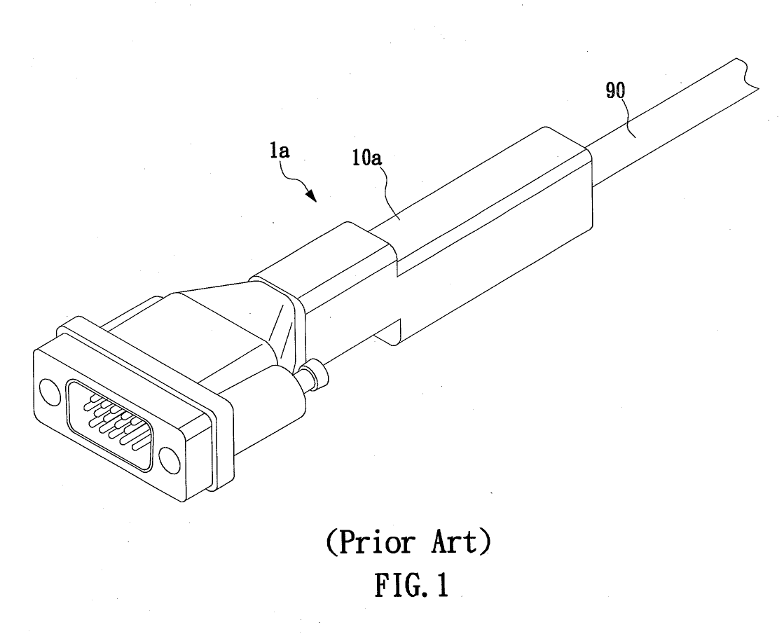

FIG. 2 illustrates a view of a signal wire protection device according to an embodiment of the invention separated from a signal wire.

FIG. 3 illustrates a view of the signal wire protection device according to an embodiment of the invention installed on the signal wire.

### DETAILED DESCRIPTION OF THE PREFERRED EMBODIMENT

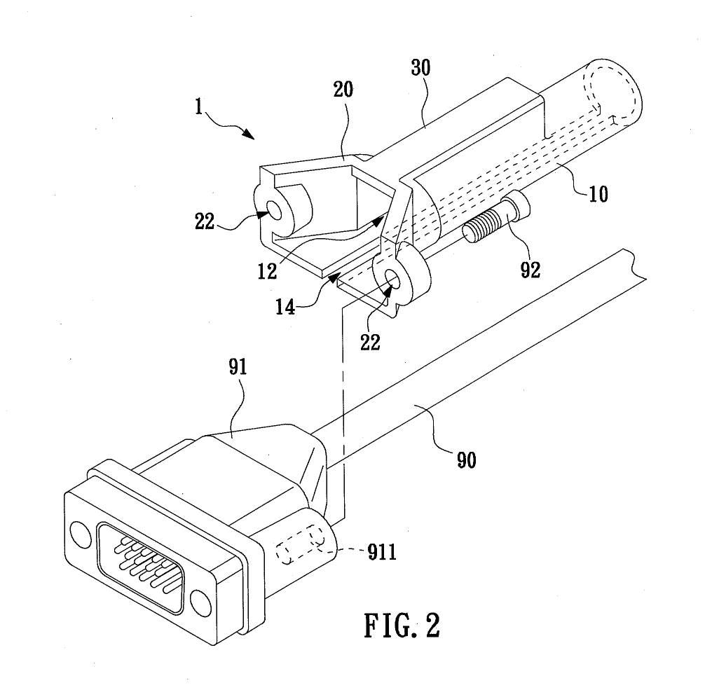

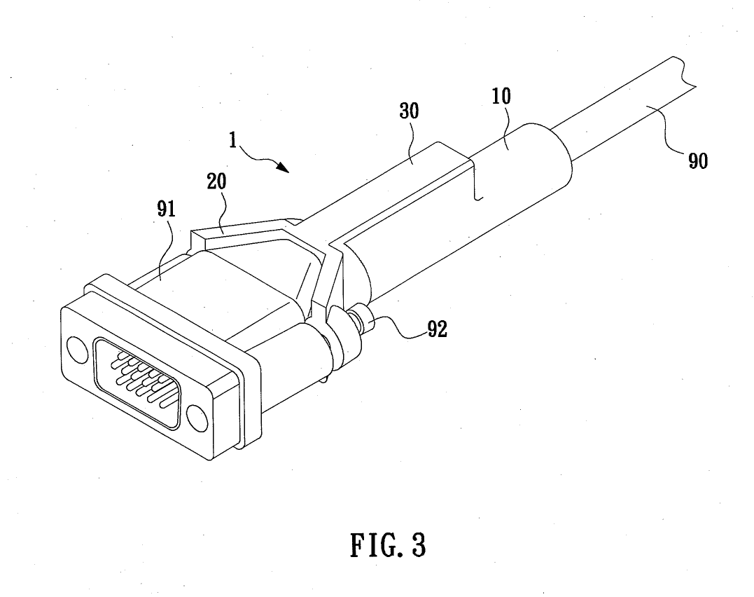

Please refer to both FIG. 2 and FIG. 3. FIG. 2 illustrates a view of a signal wire protection device according to an embodiment of the invention separated from a signal wire, and FIG. 3 illustrates a view of the signal wire protection device according to an embodiment of the invention installed on the signal wire.

As shown in FIG. 2, in an embodiment of the present invention, a signal wire protection device 1 is installed on a signal wire 90 having an adapter 91 to protect the signal wire 90. In an embodiment of the present invention, the signal wire protection device 1 includes a main body 10, a head portion 20, and an identifying portion 30.

The main body 10 is bent to form a tubular structure to form a containing space 12 in the inner space of the main body 10. The containing space 12 is provided for containing the signal wire 90 therein, thereby protecting the signal wire 90. One side of the main body 10 has an opening 14 connected to the containing space 12, and the main body 10 is made of an elastic material. When users want to install the signal wire 90 onto the signal wire protection device 1, the signal wire 90 can pass through the opening 14 to enter the containing space 12 via the elastic deformation of the main body 10.

As shown in FIG. 2 and FIG. 3, in an embodiment of the present invention, the head portion 20 is also made of an elastic material and is connected to one end of the main body 10. The head portion 20 is used for containing and fixing at least a portion of an adapter 91 of the signal wire 90 (as shown in FIG. 3). In an embodiment of the present invention, there is a pinhole 22 respectively located on the right side and the left side of the head portion 20 respectively. The pinhole 22 is provided for allowing a screw 92 to pass through the pinhole 22 and fix the signal wire protection device 1 and the signal wire 90 when the screw 92 is fastened to a through hole 911 of the adapter 91, thereby preventing the signal wire protection device 1 from breaking away with the signal wire 90.

In an embodiment of the present invention, an identifying portion 30 is formed by extending one side of the main body 10 outwardly and is formed in a rectangular cuboid shape; however, the identifying portion 30 can be formed in any other shape. The identifying portion 30 can help an operator determine an installation direction of the main body 10 so that the operators may quickly and correctly install the signal wire protection device 1 onto the signal wire 90.

In a specific embodiment of the present invention, the main body 10, the head portion 20, and the identifying portion 30 are made of silica gel and formed in one piece; however, the main body 10, the head portion 20, and the identifying portion 30 can be made of other elastic materials such as rubber having elastic restoring force.

Since the signal wire protection device 1 of the present invention is made of silica gel, the signal wire protection device 1 not only is light and inexpensive but also can be quickly installed onto the signal wire 90 via elastic deformation of itself to solve the problems encountered in the prior art.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A signal wire protection device installed on a signal wire having an adapter to protect the signal wire, wherein the signal wire protection device comprises a main body bent to form a tubular shape so that the inner space of the main body forms a containing space for containing the signal wire, one side of the main body having an opening connected to the containing space, and the main body being made of an elastic material, such that the signal wire can pass through the opening and enter the containing space via elastic deformation of the main body.

2. The signal wire protection device as claimed in claim 1, further comprising a head portion made of an elastic material, wherein the head portion is connected to an end of the main body for containing a portion of the adapter.

3. The signal wire protection device as claimed in claim 2, further comprising an identifying portion formed by extending a side of the main body outwardly.

4. The signal wire protection device as claimed in claim 3, wherein the identifying portion is substantially a rectangular cuboid shape.

5. The signal wire protection device as claimed in claim 4, wherein the head portion comprises at least one pinhole for allowing at least one screw to pass through the pinhole.

6. The signal wire protection device as claimed in claim 5, wherein the number of the pinholes is two, and the two pinholes are respectively disposed on the right side and the left side of the head portion.

7. The signal wire protection device as claimed in claim 6, wherein the main body, the head portion, and the identifying portion are made of silica gel and formed in one piece.
